(19) United States
(12) Patent Application Publication
(10) Pub. No.: US 2009/0293292 A1
(43) Pub. Date: Dec. 3, 2009

(54) Resilient razor handle

(76) Inventors: Christopher Ramm, North Attleboro, MA (US); Chandrasen Gajria, Hingham, MA (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/154,768

(22) Filed: May 27, 2008

(51) Int. Cl. B26B 21/52

(52) U.S. Cl. 30/526

(57) ABSTRACT

A razor handle including a support member. The support member has a first end, an opposed second end and a middle portion extending between the first end and the second end. The middle portion has a U-shaped cross-section extending along its length. The U-shaped cross-section has a concave inner channel portion and a convex outer portion. A first resilient layer is positioned in the concave inner channel portion. The first resilient layer is more resilient than the support member. A second resilient layer is positioned on the convex outer portion. The second resilient layer is more resilient than the support member.

### FIELD OF THE INVENTION

The present invention is directed to a handle for a razor and, more particularly, to a razor handle having a support member and resilient members.

### BACKGROUND OF THE INVENTION

Handles for razors are conventionally made of an injection molded plastic material. The handle portion of the razor is typically provided with ribs or texturing in some manner to provide a gripping surface for the user. This is particularly desirable because of the slipperiness imparted to the handle during the act of shaving resulting from the contact of the handle with soap and water during shaving.

To address these problems, handles have been provided having a rigid inner core material and a moldable flexible resilient covering layer. The flexible covering layer provides a comfortable secure surface for the user. However, due to the design or the lack thereof of the rigid core, the thickness of the flexible covering was limited. Thus, the manufacturer was not able to take full advantage of the properties of the flexible material.

The present invention addresses this shortcoming by providing a support member that allows the manufacturer to take advantage of the inherent properties of the flexible outer materials to improve the properties of the razor handle.

### SUMMARY OF THE INVENTION

The present invention comprises a razor handle comprising a support member having a first end, an opposed second end and a middle portion extending between said first end and the second end. The middle portion has a U-shaped cross-section extending along its length. The U-shaped cross-section has a concave inner channel portion and a convex outer portion. A first resilient layer is positioned in the concave inner channel portion. The first resilient layer is more resilient than the support member. The second resilient layer is positioned on the convex outer portion. The second resilient layer is more resilient than the support member.

The first resilient layer and the second resilient layer may have the same durometer values. Alternatively, the first resilient layer and the second resilient layer have different durometer values. The first resilient layer preferably has a durometer value between 10 Shore A and 40 Shore A hardness. The second resilient layer preferably has a durometer value between 10 Shore A and 40 Shore A hardness.

The middle portion preferably has a constantly changing cross-sectional shape along its length.

The first resilient layer has a maximum thickness dimension between 3 and 10 mm. The second resilient layer has a maximum thickness dimension between 3 and 10 mm.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings.

FIG. 1 is a perspective view of a razor handle of the present invention.

FIG. 2 is a perspective view of the support member of the razor handle of FIG. 1 shown without the first and second resilient layers.

FIG. 3 is a cross-sectional view taken along line 3-3 of FIG. 1.

FIG. 4 is a cross-sectional view taken along line 4-4 of FIG. 1.

FIG. 5 is a cross-sectional view taken along line 5-5 of FIG. 1.

FIG. 6 is a perspective view of another razor handle of the present invention.

FIG. 7 is a perspective view of the support member of the razor handle of FIG. 6 shown without the first and second resilient layers.

FIG. 8 is a cross-sectional view taken along 8-8 of FIG. 7.

FIGS. 9-11 show alternative cross-sectional shapes of support members for razor handles of the present invention.

### DETAILED DESCRIPTION OF THE INVENTION

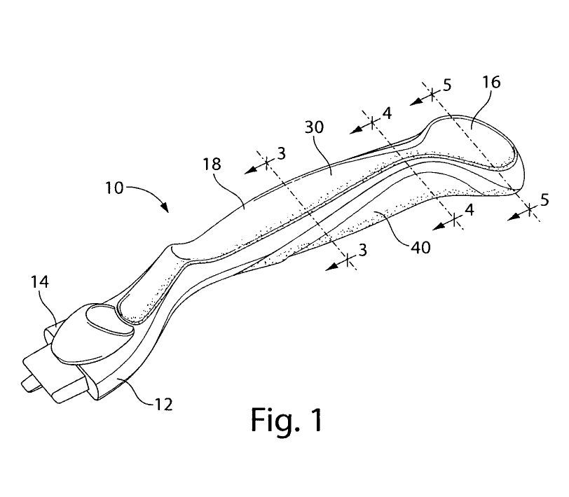

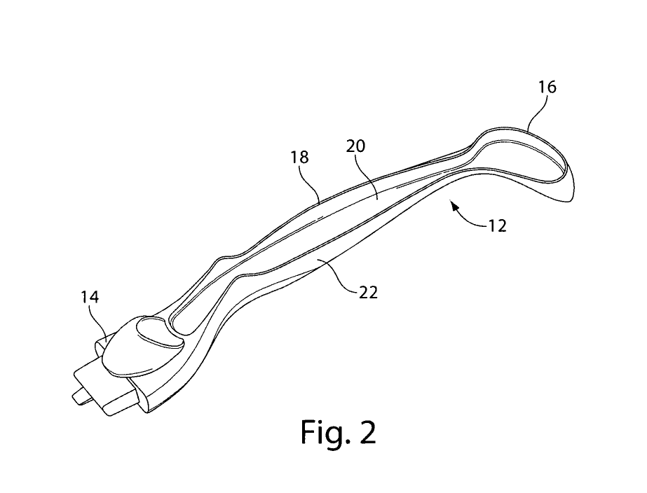

Referring now to FIGS. 1 and 2, there is shown a razor handle 10 of the present invention. Razor handle 10 comprises a substantially rigid support member 12, a first resilient layer 30 and a second resilient layer 40. Support member 12 has a first end 14, an opposed second end 16 and a middle portion 18 extending between the first end 14 and the second end 16. The first end 14 of razor handle 10 is designed to be connected to a replaceable razor cartridge. An example of a suitable connecting structure can be found in U.S. Pat. No. 5,822,869 issued to Metcalf et al. on Oct. 20, 1998. The first end 14 may also be designed to a have a razor cartridge permanently affixed thereto, as in a disposable razor.

Middle portion 18 of support member 12 comprises an inner channel portion 20 and an outer portion 22 extending along its length. Inner channel portion 20 and outer portion 22 may extend into first end 14 and opposed second end 16. The inner channel portion 20 within middle portion 18 has a constantly changing cross-sectional shape along its length. In the embodiment shown the middle portion 18 has a substantially U-shaped cross-section with a concave inner channel portion 20 and convex outer portion 22. This substantially U-shaped cross-section shape is constantly changing along its length.

Support member 12 may be formed of any rigid material. For ease of manufacturing, support member 12 is preferably formed of a thermoplastic material which can easily be molded, for example by injection molding. Suitable materials for support member 12 include but are not limited to polypropylene, polystyrene, high impact polystyrene, acrylonitrile butadiene styrene, acrylic, blends containing acrylic copolymers and blends thereof.

The support member 12 provides razor handle 10 with sufficient strength to withstand the rigors of the various use conditions the consuming public will place upon razor handle 10. The material used for support member 12 provides some inherent strength which is further bolstered by the support member 12 shape. The presence of the U-shaped cross-section enhances the overall strength of the support member 12.

It is desirable that the first resilient layer 30 and the second resilient layer 40 be both compressible and resilient. The first resilient layer 30 is positioned in the inner channel portion 20. The first resilient layer 30 is more resilient than the support member 12. The second resilient layer 40 is positioned on the outer portion 22. The second resilient layer 40 is more resilient than said support member 12. While the first resilient layer 30 and the second resilient layer 40 may have differing durometer values, preferably, the first resilient layer 30 and the second resilient layer 40 have the same durometer values. The first resilient layer 30 has a durometer value between 10 Shore A and 40 Shore A hardness. The second resilient layer 40 has a durometer value between 10 Shore A and 40 Shore A hardness.

The first and second resilient layers 30 and 40 may be formed of any resilient material. Preferably, the first and second resilient layers 30 and 40 are made of a moldable material. The material for the first and second resilient layers 30 and 40 should be compatible with the material of the support member 12. A suitable material for the first and second resilient layers 30 and 40 includes but is not limited to thermoplastic elastomers based on styrenic block copolymers, thermoplastic vulcanizates, polyurethane and blends thereof.

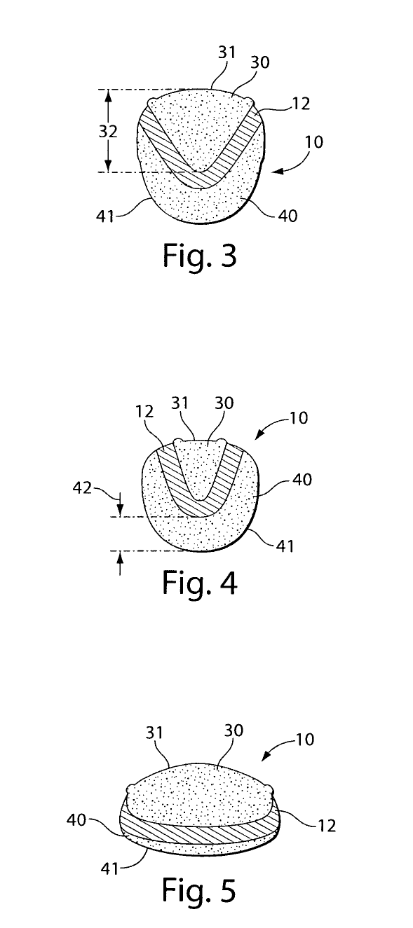

It is also preferred that the first resilient layer 30 and the second resilient layer 40 have a sufficient thickness or depth dimension allowing for ample compression resilience and security of grip by the user. Referring now to FIGS. 3-5, first resilient layer 30 is shown to have a maximum thickness dimension 32 between about 3 and 10 mm. Second resilient layer 40 is shown to have a maximum thickness dimension 42 between about 3 and 10 mm. FIGS. 3-5 also depict the various cross-sectional shapes of the support member 12 and the first and second resilient members 30 and 40, respectively, taken along various positions along the length of razor handle 10.

The razor handle 10 according to the present invention is soft, aesthetically pleasing, resilient and easy to use during a wet shaving operation.

A preferred method of manufacture of the razor handles of the present invention is by an insert molding process wherein the support member is injection molded, ejected and placed into a second mold wherein the first and second resilient layers are added by injection molding.

An alternative method of manufacture is to complete the injection molding in a two step process in a single mold. In either instance, after the support member is formed it provides part of the male mold member.

First resilient layer 30 has an outer or exposed surface 31. Second resilient layer 40 has an outer or exposed surface 41. Outer surfaces 31 and 41 are shown as smooth. However, outer surfaces 31 and 41 may be provided with ribs, bumps, dimples or protrusions to improve gripping.

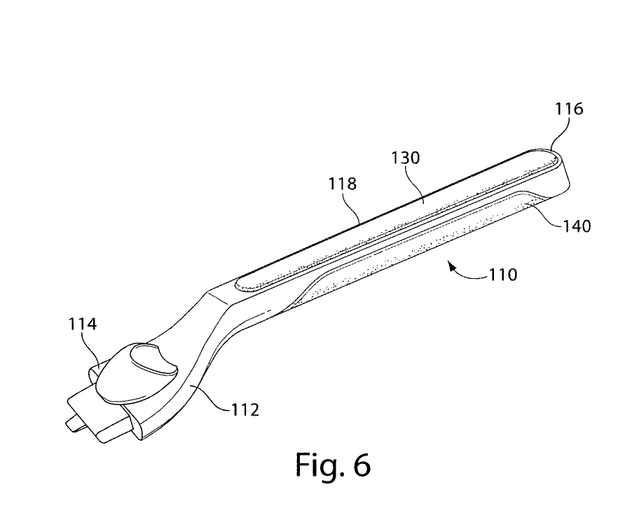

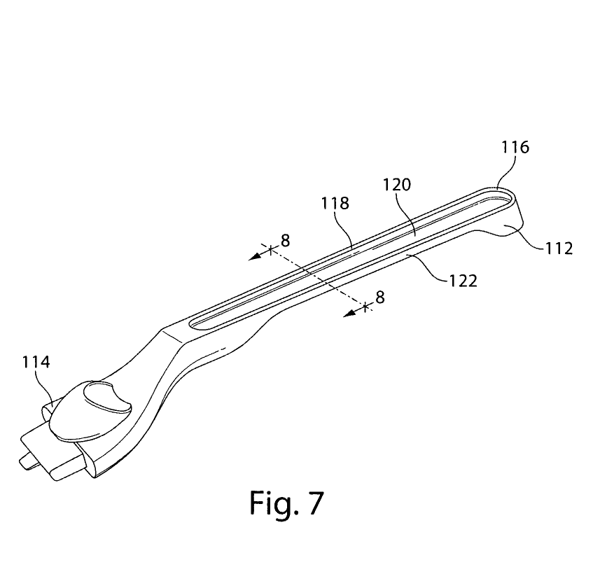

Referring now to FIGS. 6 and 7, there is shown another razor handle 110 of the present invention. Razor handle 110 comprises a substantially rigid support member 112, a first resilient layer 130 and a second resilient layer 140. Support member 112 has a first end 114, an opposed second end 116 and a middle portion 118 extending between the first end 114 and the second end 116. The first end 114 of razor handle 110 is designed to be connected to a replaceable razor cartridge. An example of a suitable connecting structure can be found in U.S. Pat. No. 5,822,869 issued to Metcalf et al. on Oct. 20, 1998. The first end 114 may also be designed to a have a razor cartridge permanently affixed thereto, as in a disposable razor.

Middle portion 118 of support member 112 comprises an inner channel portion 120 and an outer portion 122 extending along its length. Inner channel portion 120 and outer portion 122 may extend into first end 114 and opposed second end 116. The inner channel portion 120 within middle portion 118 has a constant cross-sectional shape along its length. In the embodiment shown the middle portion 118 has a substantially U-shaped cross-section with a an inner channel portion 120 and an outer portion 122. The inner channel portion 120 is concave. The outer portion 122 is convex.

Support member 112 may be formed of any rigid material. For ease of manufacturing, support member 112 is preferably formed of a thermoplastic material which can easily be molded, for example by injection molding. Suitable materials for support member 112 are mentioned above.

The support member 112 provides razor handle 110 with sufficient strength to withstand the rigors of the various use conditions the consuming public will place upon razor handle 110. The material used for support member 112 provides some inherent strength which is further bolstered by the support member 112 shape. The presence of the inner channel portion 120 enhances the overall strength of the support member 112.

It is desirable that the first resilient layer 130 and the second resilient layer 140 be both compressible and resilient. The first resilient layer 130 is positioned in the inner channel portion 120. The first resilient layer 130 is more resilient than the support member 112. The second resilient layer 140 is positioned on the outer portion 122. The second resilient layer 140 is more resilient than said support member 112. While the first resilient layer 130 and the second resilient layer 140 may have differing durometer values, preferably, the first resilient layer 130 and the second resilient layer 140 have the same durometer values. The first resilient layer 130 has a durometer value between 10 Shore A and 40 Shore A hardness. The second resilient layer 140 has a durometer value between 10 Shore A and 40 Shore A hardness.

The first and second resilient layers 130 and 140 may be formed of any resilient material. Suitable materials for the first and second resilient layers 130 and 140 are mentioned above.

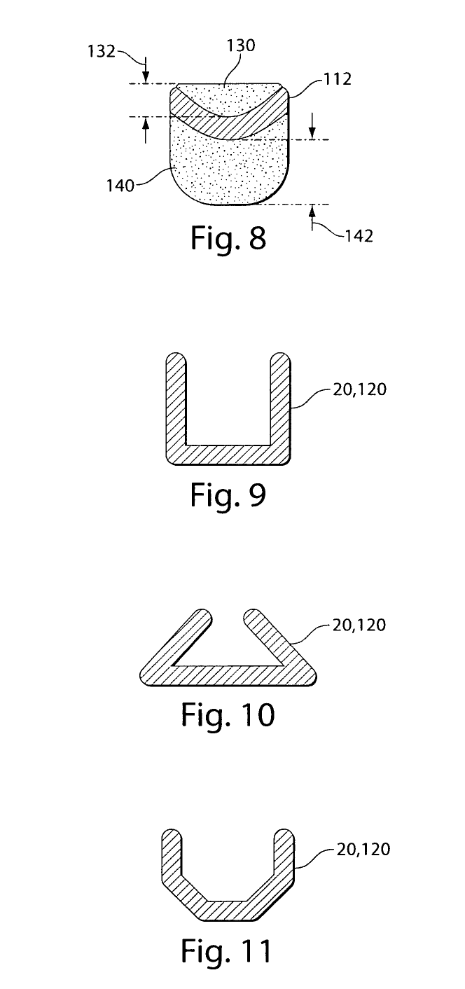

It is also preferred that the first resilient layer 130 and the second resilient layer 140 have a sufficient thickness or depth dimension allowing for ample compression resilience and security of grip by the user. Referring now to FIG. 8, first resilient layer 130 is shown to have a maximum thickness dimension 132 between about 3 and 10 mm. Second resilient layer 140 is shown to have a maximum thickness dimension 142 between about 3 and 10 mm.

The support member of the present invention may have other substantially U-shaped cross-sectional configurations with inner channel portions and outer portions. Examples of such shapes for support members 20 and 120 are shown in FIGS. 9-11.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor handle comprising
a support member, said support member having a first end, an opposed second end and a middle portion extending between said first end and said second end, said middle portion having a U-shaped cross-section extending along its length; said U-shaped cross-section having a concave inner channel portion and a convex outer portion;
a first resilient layer positioned in said concave inner channel portion, said first resilient layer being more resilient than said support member; and
a second resilient layer positioned on said convex outer portion, said second resilient layer being more resilient than said support member.

2. The razor handle according to claim 1 wherein said first resilient layer and said second resilient layer have the same durometer values.

3. The razor handle according to claim 1 wherein said first resilient layer and said second resilient layer have different durometer values.

4. The razor handle according to claim 1 wherein said first resilient layer has a durometer value between 10 Shore A and 40 Shore A hardness.

5. The razor handle according to claim 1 wherein said second resilient layer has a durometer value between 10 Shore A and 40 Shore A hardness.

6. The razor handle according to claim 1 wherein said middle portion has a constantly changing cross-sectional shape along its length.

7. The razor handle according to claim 1 wherein said first resilient layer has a maximum thickness dimension between 3 and 10 mm.

8. The razor handle according to claim 1 wherein said second resilient layer has a maximum thickness dimension between 3 and 10 mm.
